(19) United States
(12) Patent Application Publication
(10) Pub. No.: US 2018/0096375 A1
(43) Pub. Date: Apr. 5, 2018

(54) TECHNOLOGY PLATFORM PROVIDING COMMUNICATION AND TRANSACTION SERVICES BETWEEN PRODUCERS OF GOODS AND SERVICES AND THEIR AUTHORIZED REPRESENTATIVES, LOCAL BUSINESSES, AND LOCAL CUSTOMERS

(71) Applicants: Stewart Krentzman, Park Ridge, NJ (US); Ross Krentzman, Park Ridge, NJ (US)

(72) Inventors: Stewart Krentzman, Park Ridge, NJ (US); Ross Krentzman, Park Ridge, NJ (US)

(21) Appl. No.: 14/873,267

(22) Filed: Oct. 2, 2015

Related U.S. Application Data
(60) Provisional application No. 62/104,837, filed on Jan. 18, 2015.
(60) Provisional application No. 62/059,584, filed on Oct. 3, 2014.

(51) Int. Cl. G06Q 30/02; G06Q 30/06; G06F 3/0482

(52) U.S. Cl. CPC G06Q 30/0217; G06Q 30/0214; G06Q 30/0255; G06F 3/0482; G06Q 30/0276; G06Q 30/0641; G06Q 30/0247

(57) ABSTRACT

A communications and transaction services platform between producers of goods and services and their authorized representatives, local businesses, and customers is used to conduct business on a pay as you go basis. Producers of goods and services and their authorized representatives can immediately notify local businesses of information and complete transaction services for offers of goods and services. Local businesses can immediately notify local customers of any changes to their goods and services offerings so that the local customers can make a more informed purchase decision and complete the transaction. The communications and transaction services platform is an integrated application sharing consistent information and formatted for mobile, tablet and desktop screens. The communications and transaction services platform can provide producers of goods and services and their authorized representatives, local businesses and customers, with real time communications, advertising, promotional and transaction services of good, services and other offers.

### CROSS-REFERENCE TO RELATED APPLICATION

This application claims the benefit of priority of U.S. provisional application No. 62/059,584, filed Oct. 3, 2014 and U.S. provisional application No. 62/104,837, filed Jan. 18, 2015, the contents of both are herein incorporated by reference.

### BACKGROUND OF THE INVENTION

The present invention relates to technology business solutions and, more particularly, to a technology platform that provides communication and transaction services between producers of goods and services and their authorized representatives, local businesses and local customers.

Producers play a vital role in the economy. Producers are manufacturers of goods that are used in further manufacturing, processing or resale. But producers must rely on costly distribution methods to reach their local business accounts. Producers can, by example, (1) want to offer unpainted ceramic pieces to a craft retail business account so the craft retail business account will, in turn, add paint and glaze purchased from other producers and then create and offer their finished decorative ceramic pieces for sale to retail customers; (2) manufacture mayonnaise and seek to offer their mayonnaise for sale to a restaurant account to be used as an ingredient in the restaurant account's tuna salad; and (3) manufacture handbags and would want to offer the handbags to a retail account for resale. Producers, however, must rely on distributors and wholesalers to reach these accounts and may only do so if the distributor or wholesaler agrees to participate.

Producers also offer services that contribute toward the success of a business. These same producers, by example, (1) want to train a local craft retail business account with new techniques on scraping the seams of their new ceramic pieces that they have just offered for sale; (2) provide a financial discount to use additional condiment products from the mayonnaise producer; and (3) offer merchandising displays to feature the manufacturer's handbags at the retail account. Producers, however, must again rely on distributors and wholesalers to reach these accounts and may only do so if the distributor or wholesaler agrees to participate.

Some producers may also provide local services only. Local services add to the wellbeing and convenience of local customers. The producers of local services can be, by example, accountants, lawyers, medical doctors of various medical disciplines, other health care providers such as physical therapists, automobile repair services, tutors, plumbers, electricians, and the like. These producers of local services, however, have limited and expensive options to be able to participate in communications and transaction based technology. Therefore local producers of local services are left out of the technological advancements being made by their larger regional and national competitors.

To control sales and marketing expenses, producers often engage with outside sales and marketing service companies to represent their goods and services to distributors and wholesalers and they become the authorized representatives of the producer. The authorized representatives can be referred to, by example, as manufacturers' representatives, agents and brokers for specialized segments of goods and services. By example, some business segments can be food, beauty, nutrition, automotive, and medical supplies. The producer does not directly employ authorized representatives. The authorized representatives are usually compensated for their services by a commission on the sales of the producer's goods and services.

However, producers of goods and services and their authorized representatives must rely on costly distributors and wholesalers to reach local businesses and local customers. Typically these costly monopolistic distributors and wholesalers control communication and distribution of their goods, services, and promotional offerings to local businesses. Producers and their authorized representatives are charged extraordinary high service fees or are pressured to pay for additional services to get distributors and wholesalers to communicate to their local business accounts the offerings of the producer or their authorized representative.

Due to monopolistic control by distributors and wholesalers of their local business accounts, local businesses must pay a higher price for the goods and services they purchase. Local businesses may not have access to all the goods, services and promotional offers a producer or their authorized representative has to offer, if the distributor and wholesaler decide not to communicate or participate in these offers.

Customers, as a result of this monopolistic control may not have access to the best offers that a producer or their authorized representative wants to provide to them. If the distributor or wholesaler decides not to communicate the producer's or their authorized representative's offer to their local business accounts, the customer misses an offer that they may have had interest in. This results in fewer choices for the customer and often higher prices.

Due to costs, local businesses often do not have the ability to provide customers with the same web and mobile application services as their larger competitors. Typically, local businesses must rely on monopolistic web and mobile application services for directory listings, on-line ordering and customer reviews. Local businesses are charged an extraordinarily high service fee or are pressured to advertise with these services.

Local businesses often rely on various advertising methods, including web and mobile application-based services, with long lead times to communicate their offerings. As a result, local businesses cannot match or beat offers from their competitors in a timely manner.

Moreover, local businesses are often the victims of false or biased reviews from the general public who may or may not have even used their goods and services. This unfairly hurts a local business. From a customer's perspective, local customers must search many different web and mobile applications to gather information before they make their purchase decision. There is currently no easy and convenient way to compare goods and services between local businesses. Additionally, local customers do not have a convenient communication platform to receive updated information about the goods and services and conveniently purchase from local businesses.

Typically, local customers must use several static, on-line directories, individual websites and mobile applications to obtain information about the goods and services of local businesses. When placing orders, for goods, services, food, and the like, local customers often have to use a multitude of different web and mobile applications.

There is not a central location for customers to track their historical savings so that they can make an objective determination if they have received a financial benefit by using a website or mobile application. Local customers do not have a simple location to historically track how much money they have saved by using a web or mobile-based application.

Local customers may also be misled by false and biased reviews on these various on-line directories, websites and mobile applications.

As can be seen, there is a need for a technology platform that addresses many of the needs of producers of goods and services and their authorized representatives, local businesses and local customers to solve or ease many of the issues described above.

### SUMMARY OF THE INVENTION

In one aspect of the present invention, a communication and transactions technology platform comprises a producer portal accessible on a producer computing device, the producer portal allowing producers and their authorized representatives the ability to catalog items and services, establish special offers, communicate offers to businesses and process orders from businesses; a business portal, accessible on a business computing device, the business portal providing the businesses direct communication and transaction services link with the producers without relying on distributors and wholesalers, the business portal further providing an affordable, full-featured on-line web and mobile application presence that the businesses can control, the business portal further allowing the businesses to create, produce and distribute advertising messages; and a consumer portal, accessible on a consumer computing device, the consumer portal providing customers with a direct communication link from providers and businesses, the consumer portal allowing customers to manage and retain historical information about their purchase decisions in one location, wherein

the consumer portal provides the customers with at least one crawler updated periodically and at least one map, the map displaying deals available to the customer.

In another aspect of the present invention, a communication and transactions technology platform comprises a producer portal accessible on a producer computing device, the producer portal allowing producers or their authorized representatives the ability to catalog items and services, establish special offers, communicate offers to businesses and process orders from businesses; a business portal, accessible on a business computing device, the business portal providing the businesses direct communication and transaction services link with the producers, or their authorized representatives, without relying on distributors and wholesalers, the business portal further providing an affordable, full-featured on-line web and mobile application presence that the businesses can control, the business portal further allowing the businesses to create, produce and distribute advertising messages; a consumer portal, accessible on a consumer computing device, the consumer portal providing customers with a direct communication link from providers and businesses, the consumer portal allowing customers to manage and retain historical information about their purchase decisions in one location, wherein the consumer portal provides the customers with at least one crawler updated periodically and at least one map, the map displaying deals available to the customer; engagement tools to provide rewards from producers of goods and services to the businesses and the consumers; and a review system where only customers that purchased goods or services from the businesses are permitted to post a review concerning the businesses, wherein the consumer portal provides the ability of customers to track their historical savings when using the platform.

These and other features, aspects and advantages of the present invention will become better understood with reference to the following drawings, description and claims.

### BRIEF DESCRIPTION OF THE DRAWINGS

FIG. 1 is a flow chart generally describing the various steps in a method according to an exemplary embodiment of the present invention;

FIG. 2 is a flow chart generally describing the various steps in registration and use of the system of the present invention, from a producer of goods and services and authorized representative's perspective;

FIG. 3 is a flow chart generally describing the various steps in registration and use of the system of the present invention, from a business perspective;

FIGS. 4A and 4B illustrate a flow chart generally describing the various steps in registration and use of the system of the present invention, from a customer perspective;

FIG. 5 is a flow chart generally describing the various steps in creating an ad on the system of the present invention;

FIG. 6 is an image of exemplary crawlers that can be present on every page of the website, tablet and mobile application of the present invention, the crawlers having one showing live local offers present in the market and the second showing names of recent users who saved money from the last purchase at the web site, tablet or mobile application;

FIG. 7 is an exemplary screen shot showing an interactive map that can provide direction accessibility to the on-line ordering function for the consumer; and

FIG. 8 is a screen shot showing an exemplary savings account, showing a purchase history and amount saved using the application or website of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

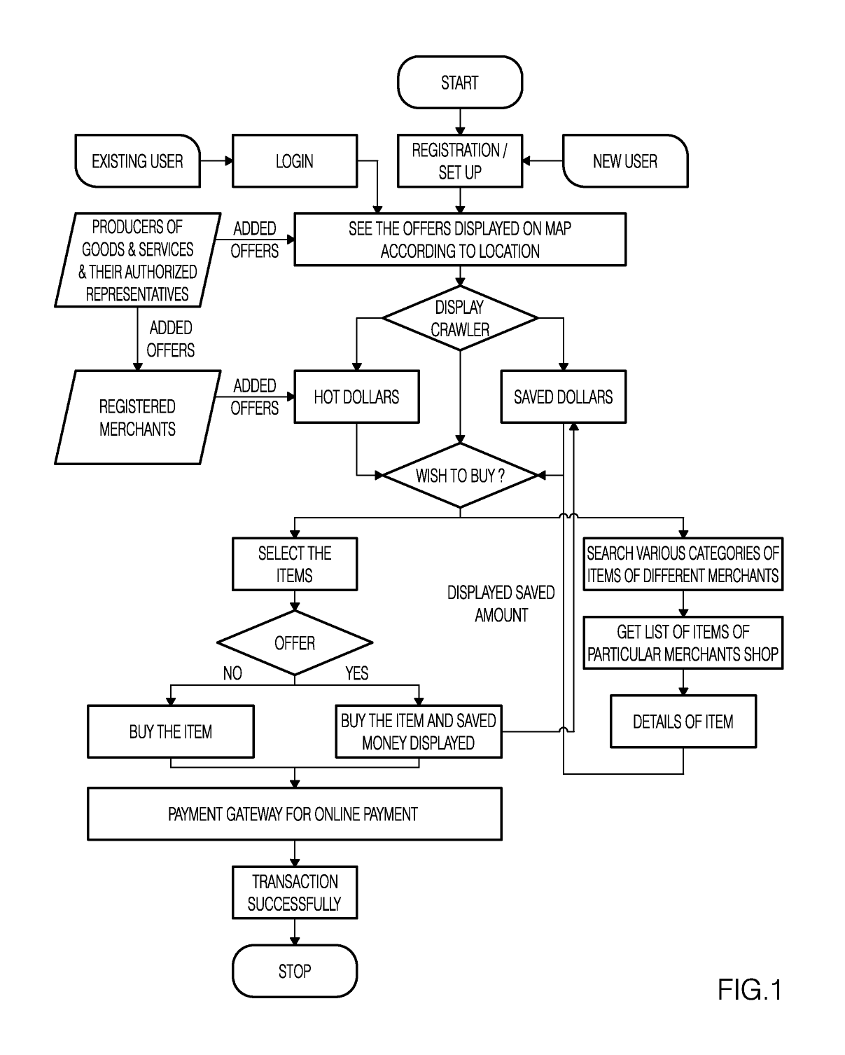

Broadly, and referring to FIG. 1, an embodiment of the present invention provides a complete communications and transaction services platform between producers of goods and services and their authorized representatives, local businesses, and customers to conduct business on a pay as you go basis. Producers of goods and services and their authorized representatives can immediately notify local businesses of information and complete transaction services for offers of goods and services that they have available. Local businesses can immediately notify local customers of any changes to their goods and services offerings so that the local customers can make a more informed purchase decision and complete the transaction. The communications and transaction services platform, hosted, for example, in the cloud, can be an integrated application sharing consistent information and formatted for mobile, tablet and desktop screens. The communications and transaction services platform of the present invention can provide producers of goods and services and their authorized representatives, local businesses and customers, with real time communications and transaction services of good, services and other offers.

The communications and transaction services platform of the present invention can include “engagement tools” for rewards from producers of goods and services to local businesses and customers. Producers, and their authorized representatives, of goods and services, for example, may provide special financial incentives to local businesses, or local customers for the purchase of selected goods or services or the use of new goods and services. For local businesses, for example, there are reward points given for adding/deleting/editing and advertising on the platform. For customers, for example, reward points are accumulated for ordering from the platform, for referring a friend, for writing and posting a review, and the like. The rewards can be redeemed for various items or services, such as additional savings on future orders, tickets to sporting events, or the like.

The communications and transaction services platform can use live crawlers that will update frequently—in real time as soon as a provider of goods and services, or a local business enters a new offer on a the mobile or web based site. The communications and transaction services platform can also include a savings account showing purchase history and amounts saved on the purchase of any goods or services via the website or mobile applications. The communications and transaction services platform can also include an interactive map, with the live crawlers of goods and services in the local area of the user, wherein the live map can be updated automatically depending on the current state of the offer.

The communications and transaction services platform can also include an integrated display of menu or other items and services of different businesses. For example, the communications and transaction platform can display local food, local fashion, local beauty and spas, local auto service and repair, local healthcare providers, local accounting and local legal services or the like and provide various purchasing mechanisms.

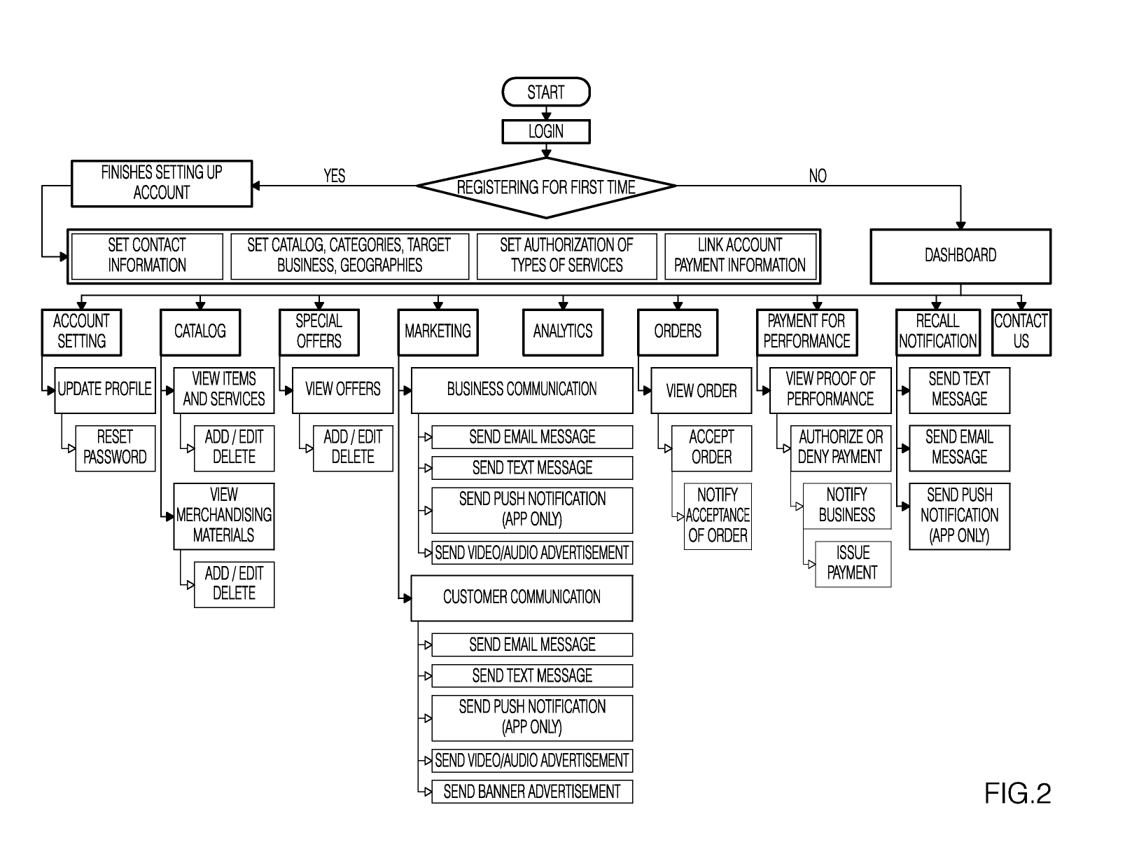

Referring to FIG. 2, the communications and transaction services platform can provide producers of goods and services and their authorized representatives with the following features: (1) Producers and their authorized representatives can instantly and directly notify local businesses of special offers for established goods and services offerings and support programs such as promotional allowances provided to local business without relying on distributors and wholesalers; (2) Producers and their authorized representatives can instantly and directly notify local businesses of new items and service offerings and support programs such as promotional allowances provided to local business without relying on distributors and wholesalers; (3) Producers and their authorized representatives can create, produce and distribute advertising messages such as, but not limited to video, audio and banner advertising and target businesses and customers by, for example their geographic distance, demographic profile, and sales history; (4) Producers and their authorized representatives can analyze the database to determine historical success of sales and marketing programs to develop new sales and marketing strategies and tactics; (5) Producers and their authorized representatives can receive and fulfill orders for established and new goods and services and marketing materials from local businesses; (6) Producers and their authorized representatives can provide direct payment to local business for promotional performance; (7) Producers and their authorized representatives can provide immediate communication tools concerning goods and service recall information for goods and services to businesses and customers, contributing to public safety; (8) Producers and their authorized representatives can address specific customer service questions from local businesses; and (9) Producers and their authorized representatives can communicate directly with local customers who are frequent or infrequent users of their goods and services.

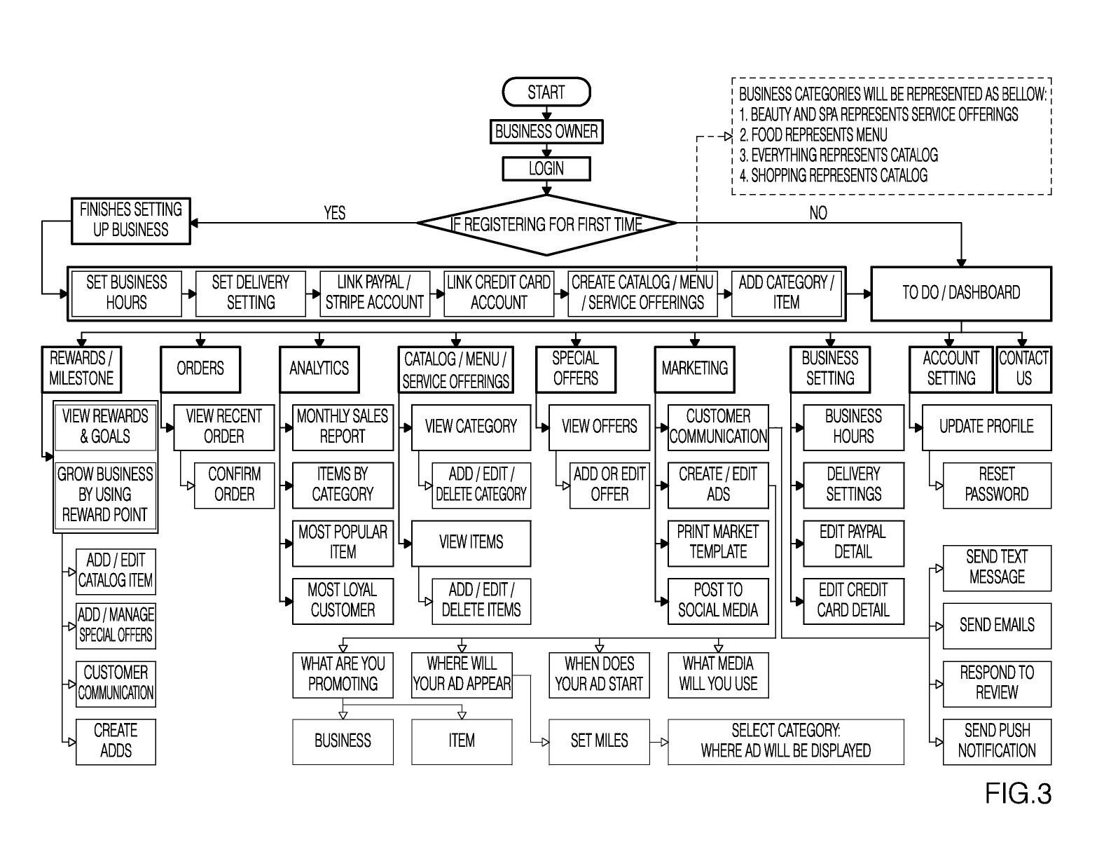

Referring to FIG. 3, the communications and transaction services platform can provide local businesses with the following features: (1) Local businesses have a direct communications and transaction services link with providers of goods and services and their representatives to make the best decisions for their local business without relying on distributors and wholesalers; (2) Local businesses can have the ability to have an affordable, full-featured on-line web and mobile application presence that the local businesses can control; (3) Local businesses can create, produce and distribute advertising messages such as, but not limited to video, audio and banner advertising, and target customers by, for example, their geographic distance, demographic profile or sales history; (4) Local businesses can respond to competitive offers by notifying local customers instantly of any changes they have made to the goods or services that they offer local customers; (5) Local businesses can create and offer their own customers incentives; (6) Local businesses can offer on-line purchasing to local customers; and (7) Local businesses and local customers can be assured of honest local customer reviews, as local customers cannot post a review without a completed purchase.

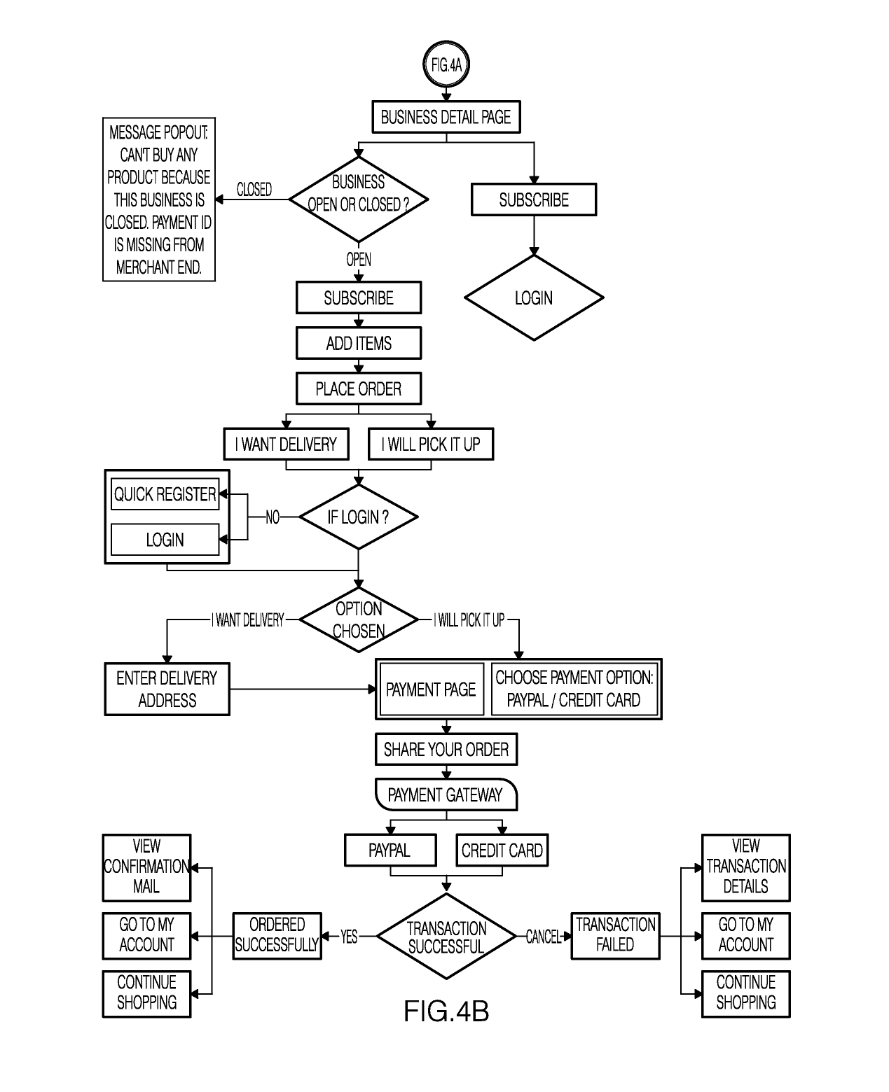

The system of the present invention provides a way for providers of goods and services, their authorized representatives and local businesses to manage their business in real time on both mobile and desktop platforms, including functionality to add, edit and delete menu/catalog items; add, edit and delete special offers; view analytics and insights regarding their online transaction services; respond to reviews; directly communicate with customers via email, text, push notifications, or the like; create and edit ads (as shown in FIG. 5) from a mobile device; print physical marketing templates; adjust store or office hours; and adjust delivery settings, including price and radius.

The local businesses can enter their menus, apparels, services or the like, from a backend portion of the communications and transactions platform, and any changes will get updated on the mobile applications and the website. For example, the menus can include food menus, product menus, nail salon service menus, professional menus, and the like. In some embodiments, the technology can display historical savings made by customers of the communications and transaction services platform. The local businesses can track availability and stock of certain items so that the customer can instantly know the availability of any goods or services in which they have interest. The local business can update their offers instantly, 24 hours a day, 7 days a week, to meet or beat business offers from competitors.

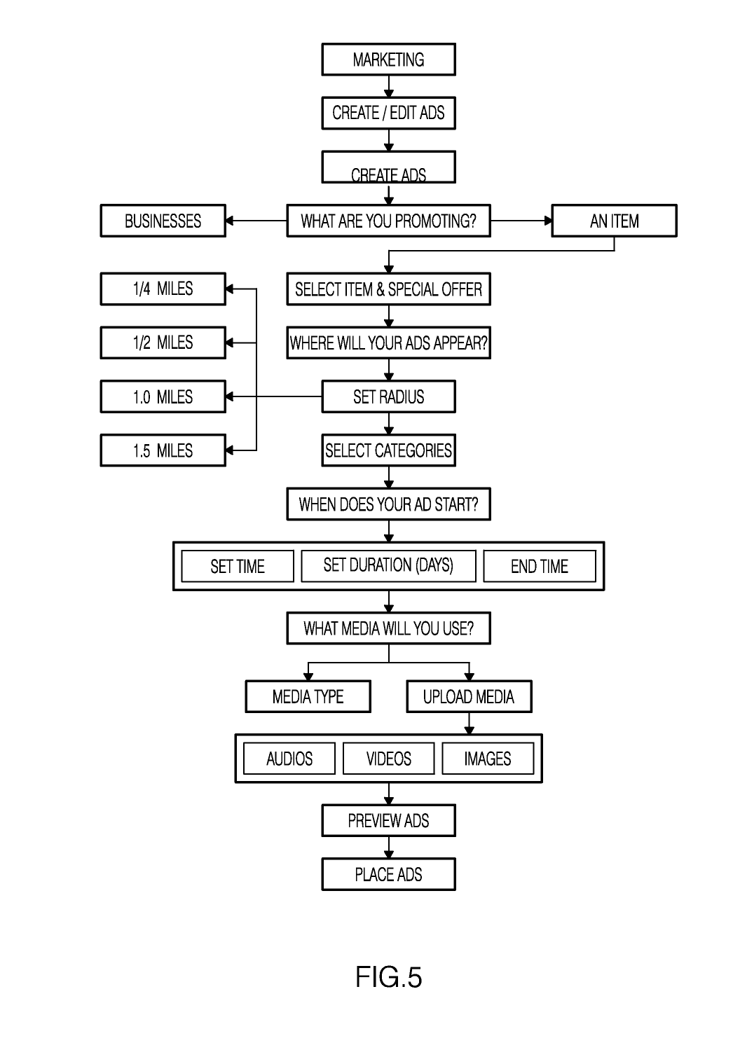

If any changes to a local businesses' goods or services are entered by the local business, they can automatically start displaying in the “hot dollars” crawler, as shown in FIG. 6. In addition to updating the website and crawler, the map can also automatically get updated and can change frequently on the front end without any fluctuation in the customer's screen.

The system of the present invention has the ability to read a user's address in one-click, has the ability for customers to re-order recent orders quickly and easily, has the ability for users to subscribe to local businesses for direct updates (i.e., push notifications, texts, emails, and the like).

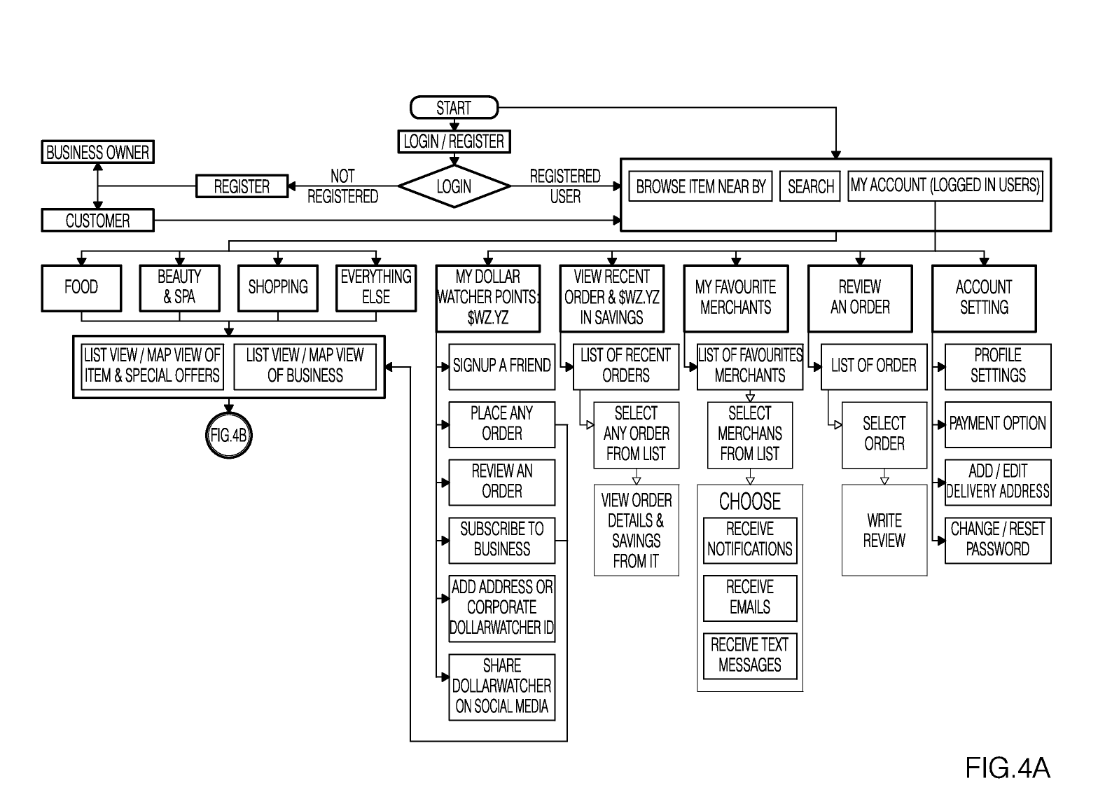

Referring to FIG. 4, the communications and transaction services platform can provide local customers with the following features: (1) Local customers have a direct communication link from providers of goods and services and their representatives to get information and promotional incentives to make the best purchase decisions and complete the transaction; (2) Local customers can find important information in one location to assist in making their purchase decisions; (3) Local customers can compare goods and services that are being offered between local businesses; (4) Local customers can be instantly notified of any changes to the goods and services; (5) Local customers can purchase goods and services from various unrelated businesses grouped conveniently under one communications and transaction platform; (6) Local customers can manage and retain historical information about their purchase decisions in one location; and (7) Local customers are assured of honest reviews, as they know someone who has purchased the goods or services can only post the review.

The above features provided to producers of goods and services and their authorized representatives, local businesses and customers can be provided in a single platform to conduct their daily business. No longer will producers of goods and services and their authorized representatives need to be dependent on costly distributors and wholesalers; local businesses will no longer be dependent on costly distributors and wholesalers who may filter the goods, services and offers that are made available to them; and customers, who, for example, will have direct communication from producers of goods and services and their authorized representatives, and from local businesses about offers that customers may want to be aware of but either has had no access to the information, or has had to search multiple web sites or applications between providers and their authorized representatives or between local business offerings to compare offers and complete their transaction.

In one embodiment of the present invention, the customer portal can include an application, such as a smart phone application, that may be accessed by the user. A search bar may be provided where a user can type a key word and a location. For example, a user may wish to find meatballs in the Philadelphia area.

After the user conducts a meatball search they have the option of seeing the meatball search results in three formats—1) as a full list of all meatball dishes of all restaurants (businesses) who have a meatball dish; 2) as a directory of all businesses who have a meatball dish; or 3) as a map that shows the actual location of the meatball search results.

Pins on the map may be labelled (by number, color, or the like), to show the actual locations based on the search results. When a pin is tapped, it opens and shows the merchant information and their actual meatball offering. Scrolling through the merchant information will show the search results (meatballs) first and then, within the map frame, continued scrolling will show the merchant's other items besides meatballs.

The menu on this map is live and the user can follow the process of clicking on their desired items and complete their entire order right from the map format. Businesses (restaurants) can update their information and cause the map details to immediately update. Specials can easily be posted and removed by the businesses, where users (customers) who use the application can have access to up-to-date information.

If a registered user purchases any goods or service from the website or mobile application, then a count of total dollars saved by him or her will automatically start to display on the “Save Dollars” crawler. As additional goods or services are purchased from the website or mobile application, the saved amount will be added in the savings account and displayed for the user to review. A user can see his or her historical savings and purchases in the website or mobile application at any time. These savings can be displayed on a per local businesses basis or a total use basis, for example. As shown in FIG. 6, two crawlers can be present on every page of the website or tablet and mobile application. The first crawler can show the live local offers present in the market. These offers are updated frequently—typically as soon as a local business adds any offer to the communications and transaction services platform. The second crawler can show the names of recent customers who saved dollars from the last purchase at the website or tablet and mobile application.

The system of the present invention, in the form of a website, mobile application, or the like, can be used by, for example, four basic users—website managers, who are responsible for the technical operation of the communications platform; producers of good and services and their authorized representatives, local businesses; and end-users (local customers).

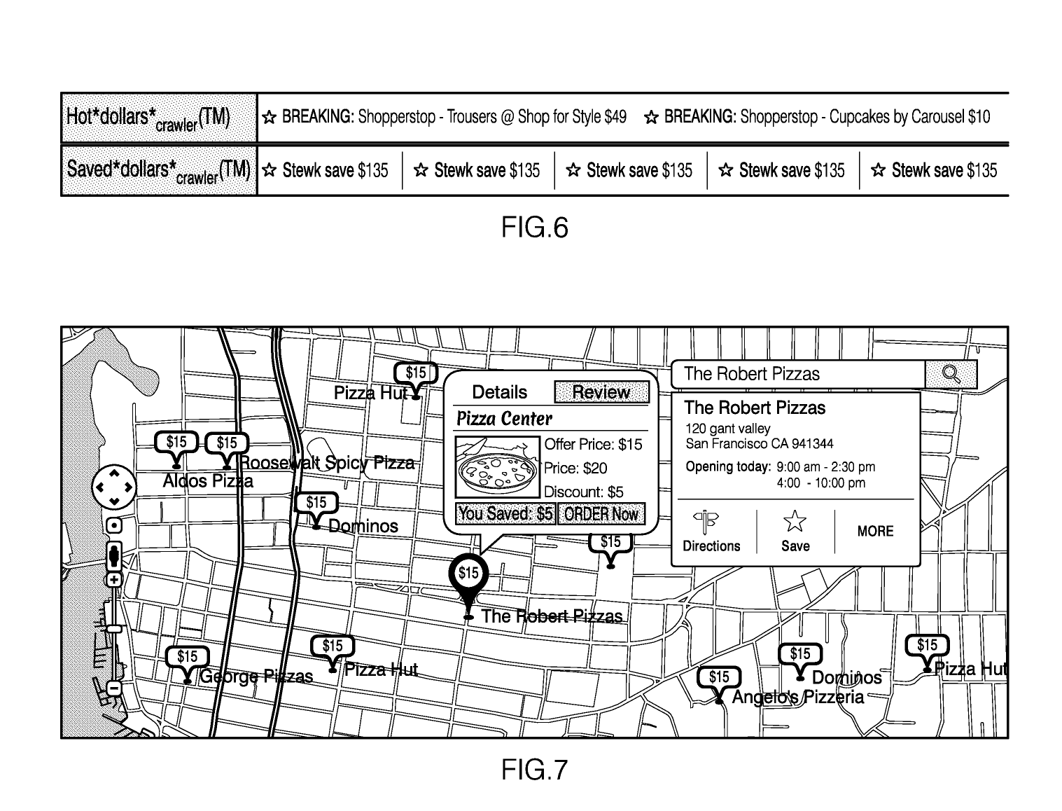

As shown in FIG. 7, when a user opens the website or application, the system takes the user's current location and shows live special offers and regular prices currently present in the local market via the interactive map. Tickers will update automatically via, for example, AJAX, periodically, such as every five minutes. Upon clicking on any one of the tickers, an info-window can open with two tabs—a first tab showing the details of the clicked item, and a second tab showing the total web site, tablet and mobile application ratings of the particular product, local business or service.

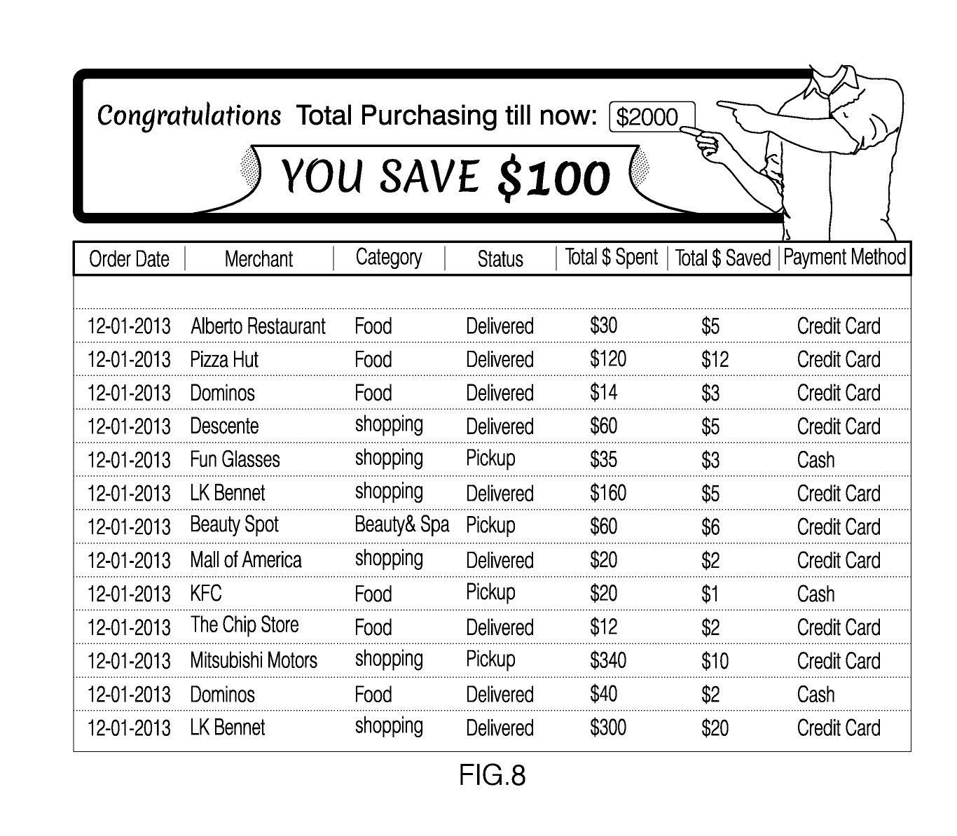

As shown in FIG. 8, when a registered user purchases any product from the system of the present invention, his or her purchase history, including, for example, total amount spent and total amount saved, can be stored in a “savings account” section of the system. The user can track their total amount of saved dollars at the end of a week, month, year or the like, by categorizing them via a particular local businesses or a combination of all local businesses. The live crawlers described herein can be used across many different web and mobile-based communication platforms to communicate with customer. For example, medical practitioners can remind patients of upcoming appointments, pharmacists can remind customers of prescriptions that are ready to be picked up, and the like. Links could be created in the crawlers with calendars to remind users of appointments or reminders from their “to do” lists.

The live crawlers can be, for example, created with PHP and Mysql. The code can be written in PHP, which is responsible for fetching data from the Mysql tables. For separate live functionalities of both crawlers, the Mysql database can operate on the updated data of two separate tables. The first of these two tables can contain a categorized data of all the items uploaded by various local businesses through the backend of the system. Here, the recent/topmost data is fetched by a PHP function and the system can display the first of the two available crawlers. The second table can have the data calculated and stored on the basis of live transaction services made by a registered user of the site.

For this crawler, a function can be written to calculate whether the purchase was an offer or not and, if it was an offer, then the calculated saved money will be fetched and shown at the front end. Of course, other database designs and coding available to one skilled in the art are contemplated within the scope of the present invention.

The interactive maps and live tickers can be implemented, for example, via PHP, Mysql, and Google maps API. The map can show live tickers by fetching all the fed data from the Mysql table, depending on the user's geographical location. The data can be fetched interactively within a time interval of, for example, five minutes. This can directly impact the front end and create a fading in and out effect of map tickers. For showing this effect on the front end, a function in PHP can be written which will process on the basis of HTML 5, W3C and CSS standards used for the front end display. Of course, other database designs and coding available to one skilled in the art are contemplated within the scope of the present invention.

In summary, the system of the present invention provides a way for providers of goods and services, their authorized representatives and local businesses to manage their business in real time on both mobile and desktop platforms, including functionality to add, edit and delete menu/catalog items; add, edit and delete special offers; view analytics and insights regarding their online transaction services; respond to reviews; directly communicate with customers via email, text, push notifications, or the like; create and edit ads (as shown in FIG. 5) from a mobile device; print physical marketing templates; adjust store or office hours; and adjust delivery settings, including price and radius.

For example, three specific aspects of the present invention provide a communications and transaction platform that (1) affords producers of goods and services, their authorized representatives as well as local businesses with a technology platform to create, produce and distribute informational and advertising messages such as, but not limited to email, text, push notifications, video, audio and banner advertising to target customers by, for example, their geographic distance, demographic profile and sales history; (2) can include “engagement tools” to reward both local businesses and customers to assure frequent use of the platform. The communications platform can provide the use of live crawlers and a savings account in any deal/retail website. The live crawlers can update frequently—as soon as a local businesses enter a new offer in the system, or a user saved a single penny on the purchase of any item via the system. The present invention further provides an interactive map with live tickers of every regular and special offer in the local area of the user and this interactive map can update automatically depending on the current state of the offer; and (3) Furthermore, the present invention provides an integrated display of menu card/stocks of different businesses that can be instantly updated as needed by providers of goods and services and their authorized representatives and local businesses.

It should be understood, of course, that the foregoing relates to exemplary embodiments of the invention and that modifications may be made without departing from the spirit and scope of the invention as set forth in the following claims.

What is claimed is:

1. A communication and transactions technology platform comprising:
a producer portal accessible on a producer computing device, the producer portal allowing producers and their authorized representatives the ability to catalog items and services, establish special offers, communicate offers to businesses and process orders from businesses;
a business portal, accessible on a business computing device, the business portal providing the businesses a direct communication and transaction services link with the producers, or their authorized representatives, without relying on distributors and wholesalers, the business portal further providing an affordable, full-featured on-line web and mobile application presence that the businesses can control, the business portal further allowing the businesses to create, produce and distribute advertising messages; and
a consumer portal, accessible on a consumer computing device, the consumer portal providing customers with a direct communication link from providers and businesses, the consumer portal allowing customers to manage and retain historical information about their purchase decisions in one location, wherein
the consumer portal provides the customers with at least one map, the map displaying deals available to the customer.

2. The communications and transactions technology platform of claim 1, wherein the at least one map includes a drop down menu that allows for an interactive business menu and services review by scrolling therethrough, wherein clicking on an item in the business menu directs the user to an ordering process for the business.

3. The communications and transactions technology platform of claim 1, wherein the producer portal provides producers and their authorized representatives with the ability to create, produce and distribute advertising messages and target customers by their geographic distance, demographic profile or sales history.

4. The communication and transactions technology platform of claim 1, wherein the business portal provides the ability for the businesses to add/delete and edit their goods and services in real time, wherein the adding/deleting and editing by the businesses can be sent by instant notifications to customers and these changes will also appear immediately in search results on the consumer portal.

5. The communication and transactions technology platform of claim 1, wherein the consumer portal provides the ability of customers to track their historical savings when using the platform.

6. The communication and transactions technology platform of claim 1, wherein the consumer portal permits customers to purchase goods and services from various unrelated businesses grouped within the platform.

7. The communication and transactions technology platform of claim 1, further comprising a review system where only customers that purchased goods or services from the businesses are permitted to post a review concerning the businesses.

8. The communication and transactions technology platform of claim 1, wherein the producer portal permits producers to instantly and directly notify the businesses of updated good and service offerings and promotional allowances without relying on distributors and wholesalers.

9. The communication and transactions technology platform of claim 1, wherein the business portal permits businesses to create and offer their own customer incentives.

10. The communication and transactions technology platform of claim 1, wherein the business portal permits businesses to offer on-line purchasing to customers.

11. The communication and transactions technology platform of claim 1, further comprising engagement tools to provide rewards from producers of goods and services to the businesses and the consumers.

12. The communication and transactions technology platform of claim 11, wherein the engagement tools include reward points given to businesses for adding, deleting, editing and advertising on the platform.

13. The communication and transactions technology platform of claim 11, wherein the engagement tools include consumer reward points accumulated by consumers for ordering from the platform, referring a friend and for writing a review.

14. A communication and transactions technology platform comprising:
a producer portal accessible on a producer computing device, the producer portal allowing producers and their authorized representatives the ability to catalog items and services, establish special offers, communicate offers to businesses and process orders from businesses;
a business portal, accessible on a business computing device, the business portal providing the businesses direct communication and transaction services link with the producers, or their authorized representatives, without relying on distributors and wholesalers, the business portal further providing an affordable, full-featured on-line web and mobile application presence that the businesses can control, the business portal further allowing the businesses to create, produce and distribute advertising messages;
a consumer portal, accessible on a consumer computing device, the consumer portal providing customers with a direct communication link from providers and businesses, the consumer portal allowing customers to manage and retain historical information about their purchase decisions in one location, wherein the consumer portal provides the customers with at least one map, the map displaying deals available to the customer;
engagement tools to provide rewards from producers of goods and services to the businesses and the consumers;
a review system where only customers that purchased goods or services from the businesses are permitted to post a review concerning the businesses, wherein
wherein the consumer portal provides the ability of customers to track their historical savings when using the platform.

15. The communications and transactions technology platform of claim 14, wherein the producer portal provides producers and their authorized representatives with the ability to create, produce and distribute advertising messages and target customers by their geographic distance, demographic profile or sales history.

16. The communication and transactions technology platform of claim 14, wherein the business portal provides the ability for the businesses to add/delete and edit their goods and services in real time, wherein the adding/deleting and editing by the businesses can be sent by instant notifications to customers and these changes will also appear immediately in search results on the consumer portal.

17. The communication and transactions technology platform of claim 14, wherein the business portal permits businesses to offer on-line purchasing to customers.

18. The communication and transactions technology platform of claim 14, wherein the producer, or their authorized representative, portal permits producers to instantly and directly notify the businesses of updated good and service offerings and promotional allowances without relying on distributors and wholesalers.

19. The communication and transactions technology platform of claim 14, wherein the engagement tools include reward points given to businesses for adding, deleting, editing and advertising on the platform.

20. The communication and transactions technology platform of claim 14, wherein the engagement tools include consumer reward points accumulated by consumers for ordering from the platform, referring a friend and for writing a review.
